(19) United States
(12) Patent Application Publication
(10) Pub. No.: US 2006/0066522 A1
(43) Pub. Date: Mar. 30, 2006

(54) Method for driving plasma display panel and plasma display device

(75) Inventors: Takashi Sasaki, Kawasaki (JP); Takayuki Kobayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Kawasaki (JP)

(21) Appl. No.: 11/236,485

(22) Filed: Sep. 28, 2005

(30) Foreign Application Priority Data
Sep. 28, 2004 (JP) 2004-281764

(51) Int. Cl. G09G 3/28

(52) U.S. Cl. 345/67

(57) ABSTRACT

A novel method for driving a plasma display panel and a plasma display device for reducing background emission due to a reset discharge are disclosed. In a three-electrode type PDP, a third (Z) electrode is provided between a first (X) electrode and a second (Y) electrode between which a discharge is caused to occur and when a reset discharge is caused to occur, the third electrode is set to a potential that makes the third electrode function as an anode for the electrode used as a cathode during the reset discharge between the first and second electrodes.

### BACKGROUND OF THE INVENTION

The present invention relates to an A/C-type plasma display panel (PDP) used as a display unit of a personal computer or a workstation, a flat TV, or a plasma display for displaying advertisements, information, etc.

In an AC-type color PDP device, an address/display separation (ADS) system is widely adopted, in which a period for specifying cells to be used for display (address period) and a display period (sustain period) for causing a discharge to occur to light cells for display are separated. In this system, charges are accumulated in the cells to be lit during the address period and a discharge is caused to occur, for display, during the sustain period by utilizing the charges.

Plasma display panels include: a two-electrode type PDP in which a plurality of first electrodes extending in a first direction are provided in parallel to each other and a plurality of second electrodes extending in a second direction perpendicular to the first direction are provided in parallel to each other; and a three-electrode type PDP in which a plurality of first electrodes and a plurality of second electrodes each extending in a first direction are alternately provided in parallel to each other and a plurality of address electrodes extending in a second direction perpendicular to the first direction are provided in parallel to each other. Recently, the three-electrode type PDP has become widely used.

In a general structure of the three-electrode type PDP, first (X) electrodes and second (Y) electrodes are alternately provided in parallel to each other on a first substrate, address electrodes extending in the direction perpendicular to the first and second electrodes are provided, on a second substrate in opposition to the first substrate, and each surface of the electrodes is covered with a dielectric layer. On the second substrate, one-directional stripe-shaped ribs, extending in parallel to the third electrode, are further provided between the third electrodes, or two-dimensional grid-shaped ribs arranged in parallel to the address electrodes and the first and second electrodes, are provided such that the cells are separated from one another and after phosphor layers are formed between the ribs, and the first and second substrates are bonded to each other. Therefore, there may be a case where the dielectric layers and the phosphor layers, and the ribs, are further formed on the third electrode.

After a reset discharge is caused to occur in all of the cells by applying a voltage between the first and second electrodes, the charges (wall charges) in the vicinity of the electrode are brought into a uniform state, and addressing is performed to selectively leave the wall charges in a cell to be lit by applying a scan pulse sequentially to the second electrode and applying an address pulse to the address electrode in synchronization with the scan pulse, a sustain discharge is caused to occur in the cell to be lit in order to light the cell, in which the wall charges are formed by addressing, by applying a sustain discharge pulse that alternately changes to the voltage of opposite polarity between the neighboring first and second electrodes between which a discharge is caused to occur. The phosphor layer emits light, which can be seen through the first substrate, due to the ultraviolet rays generated by a discharge. Because of this, the first and second electrodes are composed of an opaque bus electrode made of metal material and a transparent electrode such as an ITO film etc., whereby light generated in the phosphor layer can be seen through the transparent electrode. As the structure and operation of a general PDP are widely known, a detailed explanation will not be given here.

In the three-electrode type PDP described above, a reset discharge is caused to occur in all of the cells and it does not relate to a display. Because of this, there arises a problem that the emission by a reset discharge will be a background emission and it degrades the display contrast. Therefore, various methods by which the background emission is reduced by lowering the intensity of a reset discharge have been proposed.

For example, Japanese Unexamined Patent Publication (Kokai) No. 2001-34228 and Japanese Unexamined Patent Publication (Kokai) No. 2004-192875 have described a proposal that a rest discharge be caused to occur using the third electrode provided between the first electrode and the second electrode (non-display line) between which no discharge is caused to occur and thus the background emission is reduced. Further, Japanese Unexamined Patent Publication (Kokai) No. 2001-34228 and Japanese Unexamined Patent Publication (Kokai) No. 2004-192875 have described a configuration in which the third electrode is used for a trigger operation, discharge prevention in a non-display line (reverse slit prevention), etc.

A configuration in which the third electrode is provided between the first electrode and the second electrode (display line) between which a discharge is caused to occur is described in Japanese Unexamined Patent Publication (Kokai) No. 6-26009, Japanese Unexamined Patent Publication (Kokai) No. 2000-123741, Japanese Unexamined Patent Publication (Kokai) No. 2002-110047 etc. For example, Japanese Unexamined Patent Publication (Kokai) No. 6-260092 has described a non-address/display separation (non ADS) system PDP device that uses a PDP in which the third electrode is provided between the first electrode and the second electrode and in parallel thereto.

Japanese Unexamined Patent Publication (Kokai) No. 2000-123741 has described a PDP device that produces an interlaced display by using display lines between the first electrode and the third electrode and between the second electrode and the third electrode.

Further, Japanese Unexamined Patent Publication (Kokai) No. 2002-110047 has described various PDPs in which the third electrode is provided between the first electrode and the second electrode in parallel thereto and a configuration in which the third electrode is used for various purposes.

However, none of Japanese Unexamined Patent Publication (Kokai) No. 6-260092, Japanese Unexamined Patent Publication (Kokai) No. 2000-123741, and Japanese Unexamined Patent Publication (Kokai) No. 2002-110047 has described a reduction in background emission due to a reset discharge.

### SUMMARY OF THE INVENTION

As described above, in a PDP device, it is required to improve the display contrast by reducing background emission due to a reset discharge. Japanese Unexamined Patent Publication (Kokai) No. 2001-34228 and Japanese Unexamined Patent Publication (Kokai) No. 2004-192875 have described a proposal that a reset discharge be caused to occur using the third electrode provided in a non-display line in order to reduce background emission. However, there is a problem that no discharge is caused to occur in a display line, therefore, it is not possible to make the state of the wall charges in a cell sufficiently uniform.

Further, in an ALIS system PDP device, described in Japanese Patent No. 2801893, there exists no display line because every portion between the first (X) electrode and the second (Y) electrode is used as a display line, therefor, there arises a problem that the configuration described in Japanese Unexamined Patent Publication (Kokai) No. 2001-34228 and Japanese Unexamined Patent Publication (Kokai) No. 2004-192875 cannot be applied.

The object of the present invention is to realize a novel method for driving a plasma display panel and a plasma display device, in which background emission due to a reset discharge is reduced by a principle completely different from the conventional one.

In order to attain the above-mentioned object, in a method for driving a plasma display panel (PD) according to the present invention, a third (Z) electrode is provided between a first (X) electrode and a second (Y) electrode between which a discharge is caused to occur in a three-electrode type PDP, and when a reset discharge is caused to occur, the third electrode is set to a potential that makes the third electrode function as an anode for the electrode used as a cathode during a reset discharge between the first and second electrodes.

In other words, the method for driving a plasma display panel (PD) according to the present invention is characterized by being a method for driving a plasma display panel comprising a plurality of first electrodes and a plurality of second electrodes, alternately provided in parallel to each other, between adjacent electrodes of which a repetitive discharge is caused to occur, and a plurality of third electrodes provided between the first and second electrodes, between which the repetitive discharge is caused to occur, and covered with a dielectric layer, wherein when a reset discharge is caused to occur, which causes a discharge to occur in every cell, between the first and second electrode regardless of display data, the third electrode is set to a potential that makes the third electrode function as an anode for the electrode used as a cathode during the reset discharge between the first and second electrodes.

In a PDP, the first and second electrodes are composed of first and second bus electrodes extending in parallel to each other and first and second transparent discharge electrodes provided so as to be connected to the first and second bus electrodes for each cell. During the reset period, by applying a large voltage between the first and second electrodes, a reset discharge is caused to occur in all of the cells regardless of the state of wall charges. Conventionally, a reset discharge was caused to occur, for example, by applying a negative potential to the first electrode and a positive potential to the second electrode, and by making the first electrode function as a cathode and the second electrode function as an anode. Further, during the sustain discharge period, a repetitive sustain discharge is caused to occur by applying a sustain discharge pulse that alternately change its polarity to the first and second electrodes. In other words, the first electrode is made to function alternately as an anode and a cathode and similarly, the second electrode is made to function alternately as a cathode and an anode. In the conventional PDP, the shape of the first electrode was the same as that of the second electrode, the symmetry of discharge being taken into consideration.

The inventors of the present invention have conducted an experiment concerning the relationship between the ratio of anode area to cathode area and the amount of emission when a discharge is caused to occur and have found that, when the cathode area is larger than the anode area, the amount of emission is large. Specifically, a case where the area ratio between the discharge region of cathode and that of anode was set to 3:1 was compared to a case where it was set to 1:3, and the result was that about 1.5 times the amount of visible light was output in the case where the cathode was larger than the anode compared to the other case. Therefore, in a discharge, it can be thought that the amount of emission due to the cathode is about double that due to the anode. Conversely speaking, if the anode area is increased, the amount of emission is reduced.

Therefore, in the present invention, the third electrode is made to operate as an anode during a reset discharge by setting the third electrode to a potential that makes the third electrode function as an anode for the electrode used as a cathode during the reset discharge between the first and second electrodes. Due to this, for example, when a reset discharge is caused to occur with the first (X) electrode as a cathode and the second (Y) electrode as an anode, a discharge that generates a small amount of emission is caused to occur with a large area as an anode, which is the sum of the second (Y) electrode and the third (Z) electrode, therefore, background emission due to a reset discharge can be reduced.

During the address period or the sustain discharge period other than the reset period, for example, the third (Z) electrode is made to operate as a first (X) electrode by applying the same potential as that of the first (X) electrode to the third (Z) electrode. Due to this, the third (Z) electrode operates as an anode at the beginning of the sustain discharge period, however, it can be made to operate as an anode or a cathode afterward. Further, if the sustain discharge period is driven such that the third (Z) electrode always operates as a cathode, it is possible to improve the amount of emission, by a sustain discharge, and the display luminance.

The present invention can be applied to a method for driving a normal type plasma display panel (PD) in which the first electrode and the second electrode make a pair and a sustain discharge is caused to occur between the pair of first and second electrodes and also to a method for driving an ALIS system PDP described in Japanese Patent 2801893 in which a sustain discharge is caused to occur at every portion between the plurality of first and second electrodes. When the present invention is applied to a method for driving a normal type PDP, a common potential is applied to the plurality of third electrodes.

When the present invention is applied to a method for driving an ALIS system PDP, the third electrode is provided at every portion between the first and second electrodes. When a reset discharge is caused to occur, it is only necessary to apply a common potential to all of the third electrodes, however, during the address period and the sustain discharge period, it is necessary to divide the third (Z) electrodes into four groups and to configure so that a potential can be applied to each of the groups independently of each other.

According to the present invention, it is possible to realize a method for driving a plasma display panel and a plasma display device with high contrast display by reducing background emission due to a reset discharge.

### BRIEF DESCRIPTION OF THE DRAWINGS

The features and advantages of the invention will be more clearly understood from the following description taken in conjunction with the accompanying drawings in which:

FIG. 1 is a diagram showing a general configuration of a PDP device in a first embodiment of the present invention.

FIG. 2 is an exploded perspective view of a PDP in the first embodiment.

FIG. 3A and FIG. 3B are sectional views of the PDP in the first embodiment.

FIG. 4 is a diagram showing electrode shapes in the first embodiment.

FIG. 5 is a diagram showing drive waveforms in the first embodiment.

FIG. 6 is a diagram showing a modification example of electrode shapes.

FIG. 7 is a diagram showing drive waveforms in a second embodiment.

FIG. 8 is a diagram showing the detail of the drive waveforms during a sustain discharge period in the second embodiment.

FIG. 9 is a diagram showing a general configuration of a PDP device in a third embodiment of the present invention.

FIG. 10 is a diagram showing electrode shapes in the third embodiment.

FIG. 11 is a diagram showing drive waveforms (odd-numbered field) in the third embodiment.

FIG. 12 is a diagram showing drive waveforms (even-numbered field) in the third embodiment.

### DESCRIPTION OF THE PREFERRED EMBODIMENTS

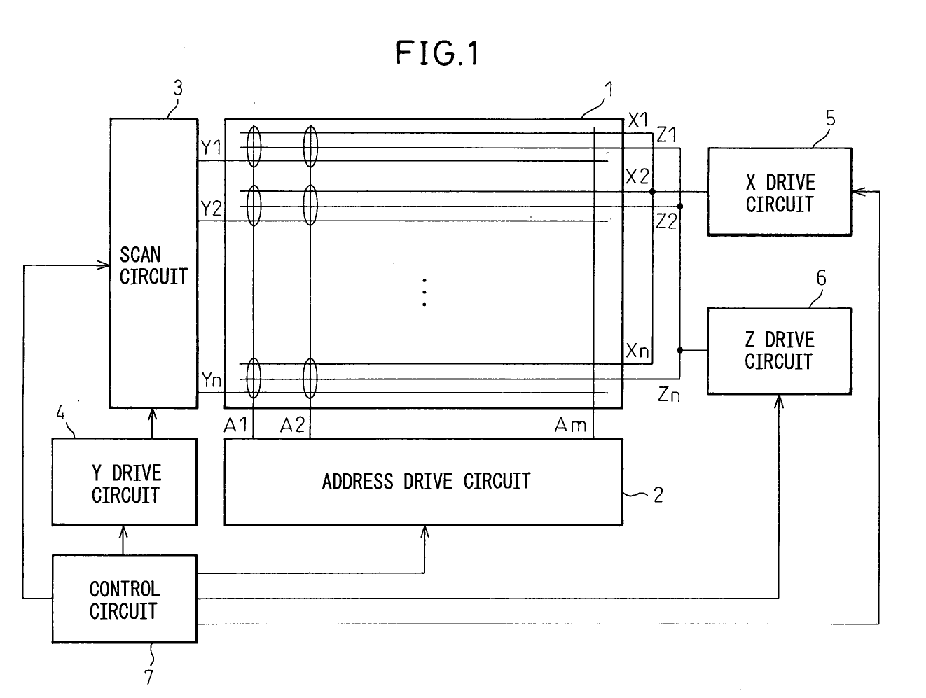

FIG. 1 is a diagram showing a general configuration of a plasma display device (PDP device) in a first embodiment of the present invention. A PDP 1 used in the PDP device in the first embodiment is a conventional PDP, in which a discharge is caused to occur between a pair of first (X) electrode and second (Y) electrode and to which the present invention is applied. As shown in FIG. 1, in the PDP 1 in the first embodiment, X electrodes X1, X2, . . . , Xn and Y electrodes Y1, Y2, . . . , Yn both extending in the transverse direction are alternately arranged and each of third electrodes Z1, Z2, . . . , Zn is arranged between each pair of X electrode and Y electrode. Therefore, n sets of the three electrodes, that is, the X electrode, the Y electrode, and the Z electrode, are formed. Further, address electrodes A1, A2, . . . , Am extending in the longitudinal direction are arranged so as to intersect the n sets of the X electrode, the Y electrode, and the Z electrode and a cell is formed at the intersection. Therefore, n display rows and m display columns are formed.

As shown in FIG. 1, the PDP device in the first embodiment comprises an address drive circuit 2 for driving the m address electrodes, a scan circuit 3 for applying a scan pulse to the n Y electrodes, a Y drive circuit 4 for commonly applying a voltage other than a scan pulse to the n Y electrodes via the scan circuit 3, an X drive circuit 5 for commonly applying a voltage to the n X electrodes, a Z drive circuit 6 for commonly applying a voltage to the n Z electrodes, and a control circuit 7 for controlling each component. The PDP device in the first embodiment differs from a conventional one in that the PDP 1 is provided with the Z electrodes and the Z drive circuit 6 for driving them, and other components are the same as those in the conventional one, therefore, only the components relating to the Z electrode are explained here and an explanation of the other components will not be given here.

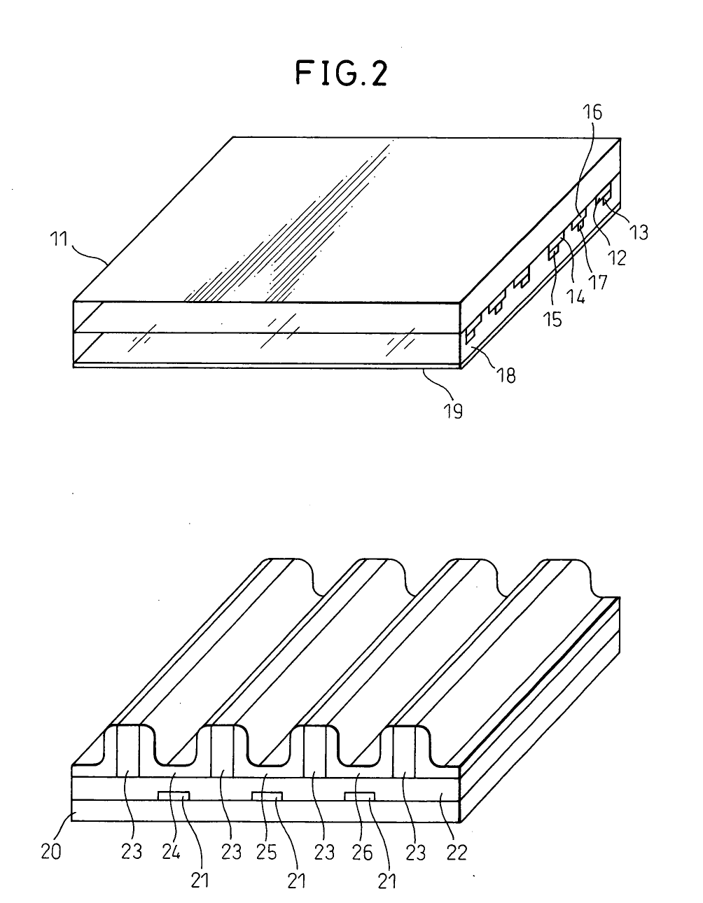

FIG. 2 is an exploded perspective view of the PDP in the first embodiment. As shown schematically, on a front (first) glass substrate 11, first (X) bus electrodes 12 and second (Y) bus electrodes 14 both extending in the transverse direction are alternately arranged in parallel to each other, making pairs. X and Y light-transmitting electrodes (discharge electrodes) 11 and 13 are provided so as to overlap the X and Y bus electrodes 12 and 14 and parts of the X and Y discharge electrodes 11 and 13 are extending toward the electrodes in opposition thereto. Between a pair of X and Y bus electrodes 12 and 14, a third discharge electrode 16 and a third bus electrode 17 are provided so as to overlap each other. For example, the bus electrodes 13, 15, and 17 are formed by a metal layer and the discharge electrodes 11, 13, and 16 are formed by, for example, an ITO layer film, and the resistances of the bus electrodes 13, 15, and 17 are smaller than or equal to the resistances of the discharge electrodes 11, 13, and 16. Hereinafter, the parts of the X and Y discharge electrodes 11 and 13 extending from the X and Y bus electrodes 12 and 14 are simply referred to as X and Y discharge electrodes 11 and 13 and the part of the Z discharge electrode 16 extending from the Z bus electrode 17 is simply referred to as the Z discharge electrode 16.

On the discharge electrodes 11, 13, and 16 and the bus electrodes 12, 14, and 17, a dielectric layer 18 is formed so as to cover these electrodes. The dielectric layer 18 is composed of SiO₂ etc. that transmits visible light and further, a protective layer 19 such as MgO is formed thereon. The protective layer 19 causes a discharge to grow by emitting electrons by ion bombardment and has an effect of a reduction in discharge voltage, discharge delay, etc. In this structure, as all of the electrodes are covered with the protective layer 19, it becomes possible to cause a discharge to occur using the effect of the protective layer even if any electrode group is made to function as a cathode. The glass substrate 11 having the above-mentioned configuration is used as a front substrate and a display is seen through the glass substrate 11.

On the other hand, on a back (second) substrate 20, address electrodes 21 are provided so as to intersect the bus electrodes 13, 15, and 17. For example, the address electrode 21 is formed by a metal layer. On the address electrode group, a dielectric layer 22 is formed. Further, longitudinal direction ribs 23 are formed thereon. Onto the side face and the bottom face of a groove formed by the rib 23 and the dielectric layer 22, phosphor layers 24, 25, and 26 that generate red, green, and blue visible light, by being excited by ultraviolet rays generated at the time of discharge, are applied.

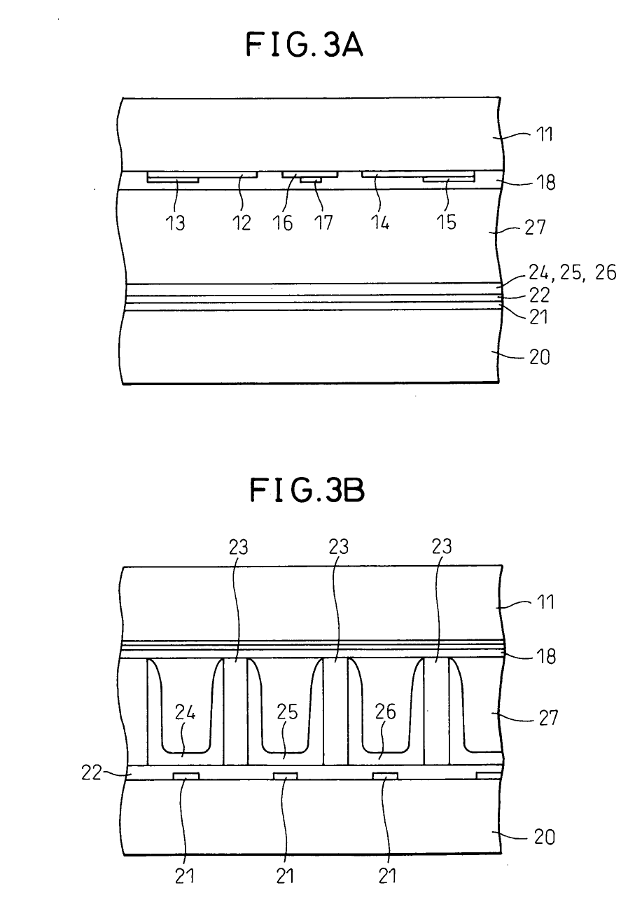

FIG. 3A and FIG. 3B are partial sectional views of the PDP in the first embodiment: FIG. 3A is a longitudinal sectional view and FIG. 3B is a transverse sectional view. Into a discharge space 27 between the front substrate 11 and the back substrate 20 defined by the ribs 23, a discharge gas such as Ne, Xe, He, etc., is sealed.

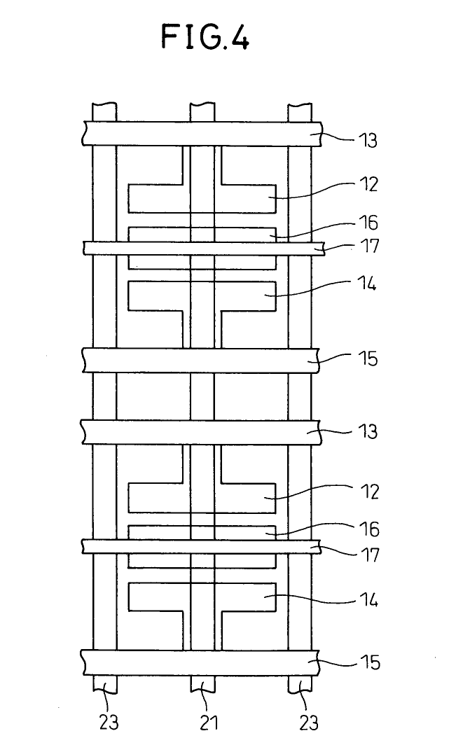

FIG. 4 is a diagram showing electrode shapes in two upper and lower cells. As shown schematically, the X bus electrode 13 and the Y bus electrode 15 are arranged in parallel to each other and the Z bus electrode 17 is arranged in parallel to the X and Y electrodes at the center thereof. Then, the ribs 23 extending in the direction perpendicular to the bus electrodes 13, 15, and 17 are arranged. The address electrode 21 is arranged between the ribs 23. At each portion defined by the ribs 23, the T-shaped X discharge electrode 12 extending from the X bus electrode 13, the T-shaped Y discharge electrode 14 extending from the Y bus electrode 15, and the Z discharge electrode 16 extending in both the upward direction and the downward direction from the Z bus electrode 17 are provided. The edge of the X discharge electrode 12 and the edge of the Z discharge electrode 16 in opposition to each other, and the edge of the Y discharge electrode 14 and the edge of the Z discharge electrode 16 in opposition to each other are parallel to the direction in which the bus electrodes 13, 15, and 17 extend and the distances therebetween are constant.

Next, the operation of the PDP device in the first embodiment is explained below. It is possible for each cell of the PDP to select only a lit state or an unlit state and it is not possible to change the lighting luminance, that is, to produce a graded display. Therefore, one frame is divided into a plurality of subfields with predetermined brightnesses and a graded display is produced by combining subfields to be lit in one frame for each cell. Normally, each subfield has the same drive sequence except for the number of sustain discharges.

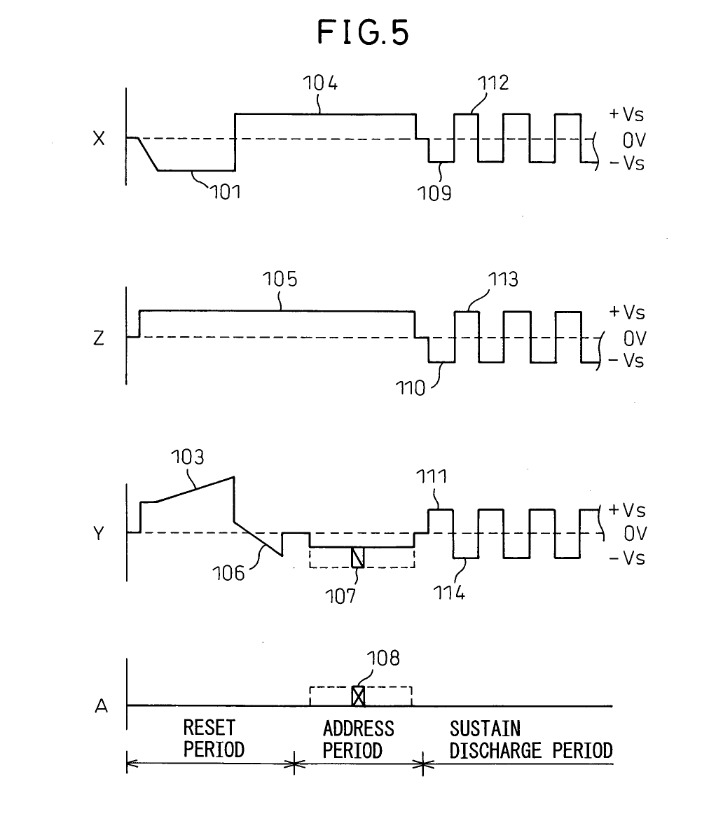

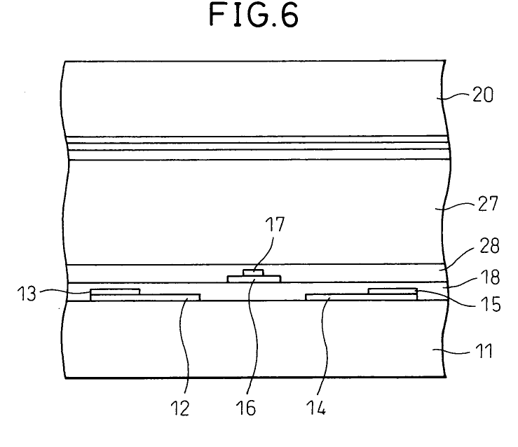

FIG. 5 is a diagram showing drive waveforms in a subfield of the PDP device of the first embodiment, and FIG. 6 is a diagram showing the detail of the drive waveforms during the sustain discharge period.

During the first half of the reset period, in a state in which 0 V is applied to the address electrode A, a negative reset pulse 101, the potential of which gradually drops and then reaches a constant potential, is applied to the X electrode and, after a predetermined potential is applied, a positive reset pulse 103, the potential of which gradually increases, is applied to the Y electrode. Then, a potential 105 of +Vs is applied to the Z electrode. Due to this, a discharge with the X discharge electrode 12 as a cathode and the Y discharge electrode 14 as an anode is caused to occur in all of the cells. What is applied here is an obtuse wave, the potential of which changes gradually, therefore, a slight discharge and formation of charges are repeated, and thus wall charges are formed uniformly in all of the cells. At this time, the potential +Vs is applied to the Z electrode although the potential is lower than that applied to the Y electrode, and the distance between the Z discharge electrode 16 and the X discharge electrode 12 is smaller than the distance between the Y discharge electrode 14 and the X discharge electrodes, therefore, a discharge with the X discharge electrode as a cathode and the Z discharge electrode 16 as an anode is caused to occur. As described above, the reset discharge is a discharge with the X discharge electrode 12 as a cathode and the Y discharge electrode 14 and the Z discharge electrode 16 as an anode, and the anode area is larger than the cathode area, therefore, the amount of emission is small and the amount of background emission is small. Due to such a reset discharge, positive wall charges are formed in the vicinity of the X discharge electrode and negative wall charges are formed in the vicinity of the Y discharge electrode and the Z discharge electrode.

During the next second half of the address period, a positive compensation potential 104 (for example, +Vs) is applied to the X electrode, the potential +Vs is applied to the Z electrode as it is, and a compensation obtuse wave 106, the potential of which gradually drops, is applied to the Y electrode, whereby the potential of the polarity opposite to that of the wall charges formed in the above-mentioned manner is applied in the form of an obtuse wave, and therefore, the number of wall charges in a cell is reduced by a slight discharge. As the potential of the X electrode and the Z electrode is higher than the potential of the Y electrode, this discharge will be a discharge with the X discharge electrode 12 and the Z discharge electrode 16 as an anode and the Y discharge electrode 14 as a cathode, and the anode area is larger than the cathode area, therefore, the amount of emission is small and the amount of background emission is small. As described above, the reset period is completed and all of the cells are put into a uniform charge state.

As described above, in the reset discharge in the PDP of the present invention, the amount of background emission is small, therefore, display contrast is improved.

During the next address period, the compensation potential 104 and the potential 105 are applied to the X electrode and the Z electrode as they are and, further, a scan pulse 107 is applied sequentially in a state in which a predetermined negative potential is applied to the Y electrode. In accordance with the application of the scan pulse 107, an address pulse 108 is applied to the address electrode of a cell to be lit. Due to this, a discharge is caused to occur between the Y electrode to which the scan pulse has been applied and the address electrode to which the address pulse has been applied and with this discharge as a trigger, a discharge is caused to occur between the X discharge electrode and the Y discharge electrode and between the Z discharge electrode and the Y discharge electrode. By this address discharge, negative wall charges are formed in the vicinity of the X discharge electrode and the Z discharge electrode (on the surface of the dielectric layer) and positive wall charges are formed in the vicinity of the Y discharge electrode. As no address discharge is caused to occur in a cell to which neither scan pulse nor address pulse is applied, therefore, the number of wall charges at the time of reset is maintained. During the address period, the above-mentioned operation is carried out by applying the scan pulse sequentially to all of the Y electrodes and an address discharge is caused to occur in all of the cells to be lit on the entire surface of the panel.

There may be a case where a pulse for adjusting the wall charges formed during the reset period is applied at the end of the address period to a cell in which no address discharge has been caused to occur.

During the sustain discharge period, the same drive waveforms as those applied to the X electrode are applied to the Z electrode. Therefore, the Z discharge electrode operates in the same manner as the X discharge electrode and this operation will be one in the case where an X discharge electrode having a large area is provided. First, negative sustain discharge pulses 109 and 110 having a potential −Vs is applied to the X electrode and Z electrode, and a positive sustain discharge pulse 111 having the potential +Vs is applied to the Y electrode. In a cell in which an address discharge has been caused to occur, the voltage due to the positive wall charges formed in the vicinity of the Y discharge electrode is added to the potential +Vs and the voltage due to the negative wall charges formed in the vicinity of the X discharge electrode and the Z discharge electrode is added to the potential −Vs. Due to this, the voltage between the X discharge electrode and the Y discharge electrode and between the Z discharge electrode and the Y discharge electrode exceeds the discharge start voltage and a discharge is caused to occur first across the small distance between the Z discharge electrode and the Y discharge electrode, and with this discharge as a trigger, a transition takes place to a discharge across the large distance between the X discharge electrode and the Y discharge electrode. The discharge between the X discharge electrode and the Y discharge electrode is a long-distance discharge and a discharge with excellent emission efficiency. At the end of this discharge, positive wall charges are formed in the vicinity of the X discharge electrode and the Z discharge electrode and negative wall charges are formed in the vicinity of the Y discharge electrode.

Next, positive sustain discharge pulses 112 and 113 having the potential +Vs are applied to the X electrode and the Z electrode and a negative sustain discharge pulse 114 having the potential −Vs is applied to the Y electrode. In a cell in which the first sustain discharge has been caused to occur, the voltage due to the positive wall charges formed in the vicinity of the X discharge electrode and the Z discharge electrode is added to the potential +Vs and the voltage due to the negative wall charges formed in the vicinity of the Y electrode is added to the potential −Vs. Due to this, the voltage between the X discharge electrode and the Y discharge electrode and between the Z discharge electrode and the Y discharge electrode exceeds the discharge start voltage and the second sustain discharge is caused to occur between the X discharge electrode and the Y electrode and between the Z discharge electrode and the Y electrode. At the end of the second sustain discharge, negative wall charges are formed in the vicinity of the X discharge electrode and the Z discharge electrode and positive wall charges are formed in the vicinity of the Y discharge electrode.

After this, by similarly applying the sustain discharge pulse the polarity of which changes alternately to the X electrode and the Y electrode, and to the Z electrode and the Y electrode, a sustain discharge is caused to occur repeatedly.

The first embodiment of the present invention is described as above, however, there can be various modified examples of the electrode structure and shape.

FIG. 6 is a diagram showing a modified example of an electrode structure. In the first embodiment, as shown in FIG. 3A, the Z electrodes (the Z discharge electrode 16, the Z bus electrode 17) are formed in the same layer in which the X electrodes (the X discharge electrode 12, the X bus electrode 13) and the Y electrodes (the Y discharge electrode 14, the Y bus electrode 15) are formed. In this configuration, it is possible to form the Z electrode in the same process as that for the X the electrode and the Y electrode and it is not necessary to employ a new process for providing the Z electrode. However, there arises a problem that as the Z electrode is provided between the X discharge electrode 12 and the Y discharge electrode 14, the Z electrode makes a short circuit with the X discharge electrode 12 and the Y discharge electrode 14 owing to the variations in position and line width in the manufacturing process, and the yield is reduced. Therefore, in the modification example in FIG. 6, the Z electrodes (the Z discharge electrode 16, the Z bus electrode 17) are formed on the dielectric layer 18 covering the X electrodes (the X discharge electrode 12, the X bus electrode 13) and the Y electrodes (the Y discharge electrode 14, the Y bus electrode 15) and further, a dielectric layer 28 is formed thereon so as to cover them. In this configuration also, the same operation as that in the first embodiment is possible.

The modification example in FIG. 6 has a problem that the manufacturing cost is pushed up because the process for providing the Z electrode is added compared to the first embodiment, however, as the Z electrode is formed in a layer different from that in which the X electrode and the Y electrode are formed, the Z electrode does not make a short circuit with the X discharge electrode 12 and the Y discharge electrode 14 and the yield is not reduced because there is no short circuit. Further, as the Z electrode is provided in a different layer, it is also possible to make very small the distances between the Z electrode and the X discharge electrode 12 and between the Z electrode and the Y discharge electrode 14 when seen in the direction perpendicular to the substrate, and a distance corresponding to the Paschen minimum, at which the discharge start voltage is a minimum, can also be obtained.

Further, as shown in FIG. 4, the X discharge electrode 12 and the Y discharge electrode 14 have T-shaped figures and are independent of the discharge electrodes in neighboring cells, however, it is also possible to provide the X and Y discharge electrodes in parallel to the X and Y bus electrodes and use the conventional electrode shapes in which electrodes for connecting the X and Y bus electrodes and the X and Y discharge electrodes are formed at the portion of the ribs.

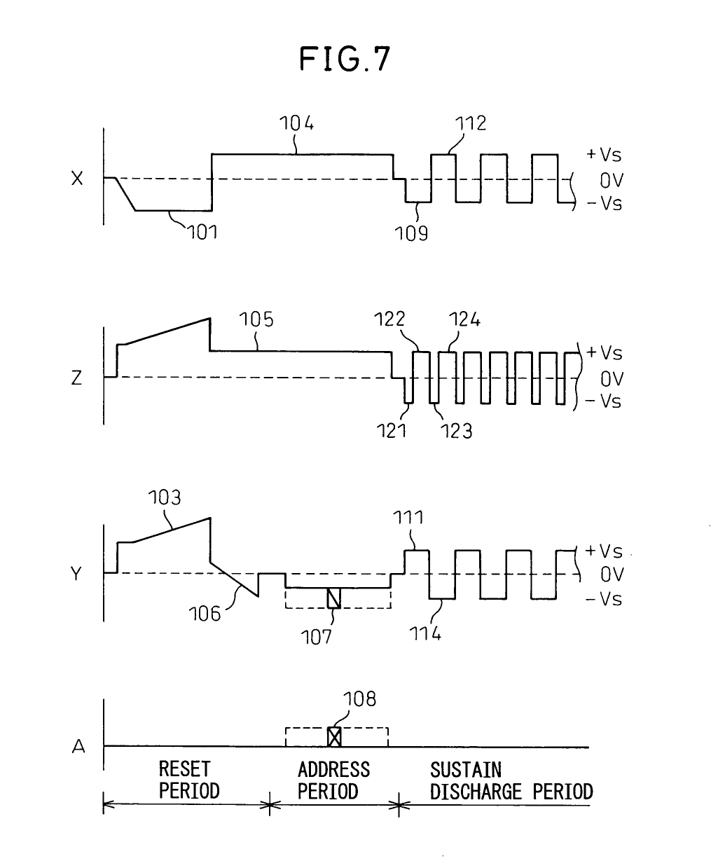

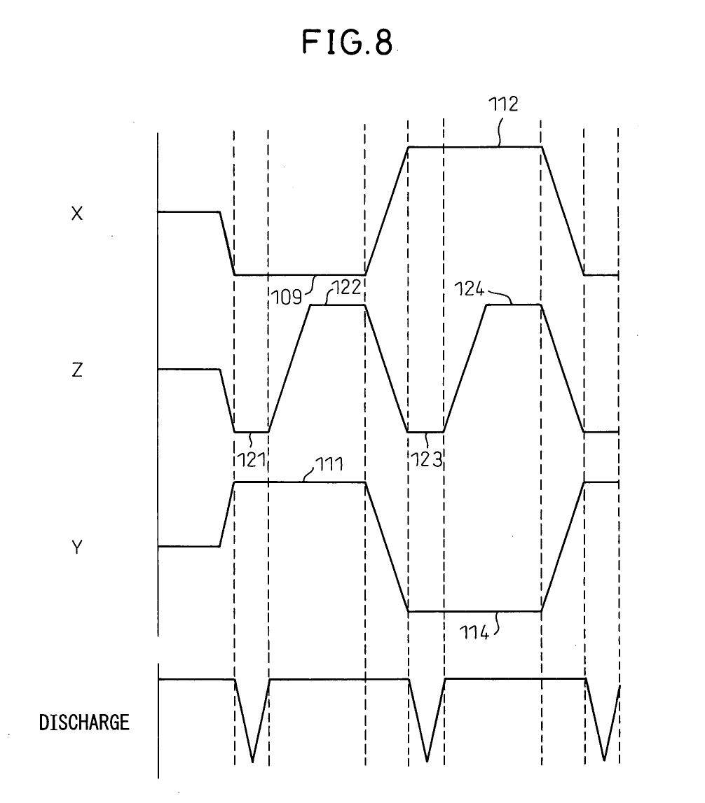

FIG. 7 is a diagram showing drive waveforms in a PDP device in a second embodiment of the present invention. The PDP device in the second embodiment has a configuration similar to that of the PDP device in the first embodiment, however, it differs from the first embodiment in drive waveforms to be applied to the Z electrode during the reset period and the sustain discharge period. FIG. 8 is a diagram showing the detail of the drive waveforms during the sustain discharge period.

During the first half of the reset period in the second embodiment, as shown in FIG. 7, after a predetermined potential is applied, the positive reset pulse 103, the potential of which gradually increases, is applied to the Z electrode as well as the Y electrode. Further, during the second half of the reset period, as in the first embodiment, the potential +Vs is applied to the Z electrode. Due to this, during the reset period, the higher one of the potentials applied to the X electrode and the Y electrode is applied to the Z electrode and a reset discharge always using the Z electrode as an anode is caused to occur. Therefore, the Z electrode in the second embodiment operates as a main anode during the period of a reset discharge more than that in the first embodiment, and the amount of emission due to the reset discharge is further reduced and, therefore, the background emission can be reduced.

During the sustain discharge period in the second embodiment, the negative sustain discharge pulse 109 having the potential −Vs is applied to the X electrode, a negative pulse 121 having the potential −Vs is applied to the Z electrode, and the positive sustain discharge pulse 111 having the potential +Vs is applied to the Y electrode. In a cell in which an address discharge has been caused to occur, the voltage due to the positive wall charges formed in the vicinity of the Y electrode is added to the potential +Vs and the voltage due to the negative wall charges formed in the vicinity of the X electrode and the Z electrode is added to the potential −Vs. Due to this, the voltage between the X electrode and the Y electrode and between the Z electrode and the Y electrode exceeds the discharge start voltage and first, a discharge is caused to start across the small distance between the Z discharge electrode and the Y discharge electrode and, with this discharge as a trigger, a transition takes place to a discharge across the large distance between the X electrode and the Y electrode. The discharge between the X electrode and the Y electrode is a long-distance discharge and excellent in emission efficiency.

As shown in FIG. 8, this discharge is caused to occur when −Vs is applied to the X and Z electrodes and +Vs is applied to the Y electrode (in fact, the discharge is caused to occur, with a delay, somewhat after the application of the potential), and in a certain period of time, the discharge intensity reaches the peak value and then, the discharge intensity falls. In the second embodiment, when the discharge intensity falls sufficiently, a positive pulse 122 having the potential +Vs is applied to the Z electrode. The negative wall charges in the vicinity of the X electrode and the Z electrode and the positive wall discharge in the vicinity of the Y electrode have disappeared due to the above-mentioned discharge and the positive charges generated by the discharge move to the vicinity of the X electrode and the Z electrode and the negative charges move to the vicinity of the Y electrode, however, a sufficient number of wall charges is not formed yet. Further, the voltage due to the charges in the vicinity of the Z electrode raises the potential of the Z electrode, however, the voltage due to the charges in the vicinity of the X electrode and the Y electrode also raises the potential of the X electrode and reduces the potential of the Y electrode, therefore, no discharge is caused to occur between the X electrode and the Z electrode and between the Y electrode and the Z electrode even if the pulse 122 is applied. By applying the potential +Vs to the Z electrode, the positive charges in the vicinity of the Z electrode are not accumulated on the dielectric layer immediately above the Z electrode but, conversely, the negative charges move onto the dielectric layer immediately above the Z electrode and negative wall charges are formed. Positive wall charges are formed on the dielectric layer immediately above the X electrode and negative wall charges are formed on the dielectric layer immediately above the Y electrode.

The timing at which the positive pulse 122 having the potential +Vs is applied to the Z electrode is determined as follows. Ultraviolet rays are generated by a discharge, the ultraviolet rays excite phosphors to generate visible light, and the light is output to the outside of the panel through the glass substrate. The ultraviolet rays are absorbed by the glass substrate, not output to the outside and therefore, the ultraviolet rays cannot be detected outside the panel. Along with the ultraviolet rays, infrared rays are also generated by a discharge and the timing at which the ultraviolet rays are generated is the same as that at which the infrared rays are generated. Therefore, it is possible to detect the change in state of a discharge by measuring the infrared rays. The intensity of the discharge in FIG. 8 is obtained by measuring infrared rays. Here, when the intensity of the infrared rays falls to 10% of the peak value, the application of the pulse 122 is started.

As described above, negative wall charges are formed in the vicinity of the Y electrode and the Z electrode and positive wall charges are formed in the vicinity of the X electrode. Next, if the pulse 112 having the potential +Vs is applied to the X electrode, the pulse 114 having the potential −Vs is applied to the Y electrode, and a pulse 123 having the potential −Vs is applied to the Z electrode, the voltage between the X electrode and the Y electrode and between the X electrode and the Z electrode exceeds the discharge start voltage because the voltage due to the wall charges is added thereto. Due to this, first, a discharge is caused to start across the small distance between the Z discharge electrode and the X discharge electrode and with this discharge as a trigger, a transition takes place to a discharge across the large distance between the X electrode and the Y electrode. This discharge uses the Z electrode as a cathode. Then, when the discharge intensity falls sufficiently, a negative pulse 124 having the potential −Vs is applied to the Z electrode. Due to this, negative wall charges are formed in the vicinity of the X electrode and the Z electrode and positive wall charges are formed in the vicinity of the Y electrode. Similarly, a sustain discharge is caused to occur repeatedly, using always the Z electrode a cathode, by applying a sustain discharge pulse that changes its polarity alternately to the X electrode and the Y electrode and by applying a pulse, the frequency of which is double that of the sustain discharge pulse, to the Z electrode.

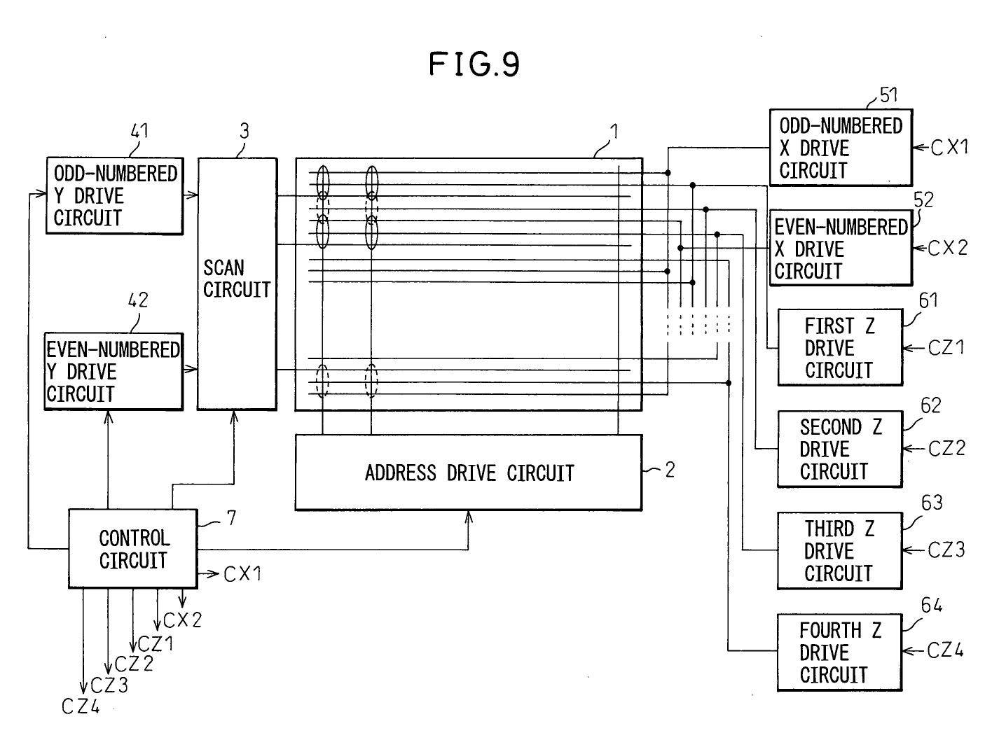

FIG. 9 is a diagram showing a general configuration of a PDP device in a third embodiment of the present invention. The third embodiment is an example in which the present invention is applied to an ALIS system PDP device described in Japanese Patent No. 2801893, and in the configuration in which first and second electrodes (X and Y electrodes) are provided on a first substrate (a transparent substrate) and address electrodes are provided on a second substrate (a back substrate), a third electrode (a Z electrode) is provided between the X electrode and the Y electrode. As the ALIS system is described in Japanese Patent No. 2801893, a detailed explanation will not be given here.

As shown in FIG. 9, the plasma display panel 1 has a plurality of first electrodes (X electrodes) and second electrodes (Y electrodes) extending in the transverse direction (lengthwise direction). The plurality of X electrodes and Y electrodes are alternately arranged and the number of X electrodes is greater than that of Y electrodes by one. Between the X electrode and the Y electrode, a third electrode (a Z electrode) is arranged. Therefore, the number of Z electrodes is double that of Y electrodes. The address electrode extends in the direction perpendicular to the X, Y, and Z electrodes. In an ALIS system, all of the portions between the X electrode and the Y electrode are used as display lines and odd-numbered display lines and even-numbered display lines are used to produce an interlaced display. In other words, odd-numbered display lines are formed between an odd-numbered X electrode and an odd-numbered Y electrode and between an even-numbered X electrode and an even-numbered Y electrode, and even-numbered display lines are formed between an odd-numbered Y electrode and an even-numbered X electrode and between an even-numbered Y electrode and an odd-numbered Y electrode. One display field is composed of an odd-numbered field and an even-numbered field, and in the odd-numbered field, odd-numbered display lines are displayed and in the even-numbered field, even-numbered display lines are displayed. Therefore, the respective Z electrodes exist between the respective odd-numbered display lines and the respective even-numbered display lines. Here, the Z electrodes provided between an odd-numbered X electrode and an odd-numbered Y electrode are referred to as the Z electrodes in a first group, the Z electrodes provided between an odd-numbered Y electrode and an even-numbered X electrode are referred to as the Z electrodes in a second group, the Z electrodes provided between an even-numbered X electrode and an even-numbered Y electrode are referred to as the Z electrodes in a third group, and the Z electrodes provided between an even-numbered Y electrode and an odd-numbered X electrode are referred to as the Z electrodes in a fourth group, respectively. In other words, the (4p+1)-th (p is a natural number) Z electrode is a Z electrode in the first group, the (4p+2)-th Z electrode is a Z electrode in the second group, the (4p+3)-th Z electrode is a Z electrode in the third group, and the (4p+4)-th electrode is a Z electrode in the fourth group.

As shown in FIG. 9, the PDP device in the second embodiment comprises the address drive circuit 2 for driving the address electrode, the scan circuit 3 for applying a scan pulse to the Y electrode, an odd-numbered Y drive circuit 41 for commonly applying a voltage other than the scan pulse to an odd-numbered Y electrode via the scan circuit 3, an even-numbered Y drive circuit 42 for commonly applying a voltage other than the scan pulse to an even-numbered Y electrode via the scan circuit 3, an odd-numbered X drive circuit 51 for commonly applying a voltage to an odd-numbered X electrode, an even-numbered X drive circuit 52 for commonly applying a voltage to an even-numbered X electrode, a first Z drive circuit 61 for commonly driving the Z electrodes in the first group, a second Z drive circuit 62 for commonly driving the Z electrodes in the second group, a third Z drive circuit 63 for commonly driving the Z electrodes in the third group, a fourth Z drive circuit 64 for commonly driving the Z electrodes in the fourth group, and the control circuit 7 for controlling each component.

The PDP in the second embodiment has the same structure as that in the first embodiment except in that the X discharge electrode and the Y discharge electrode are provided on both sides of the X bus electrode and the Y bus electrode, respectively, and that the Z electrode is provided at every portion between the X bus electrode and the Y bus electrode, and therefore, an exploded perspective view is omitted here. It is also possible to form the Z electrode in the same layer in which the X and Y electrodes are formed as shown in FIG. 3 or to form in a layer different from that in which the X and Y electrodes are formed as shown in FIG. 6.

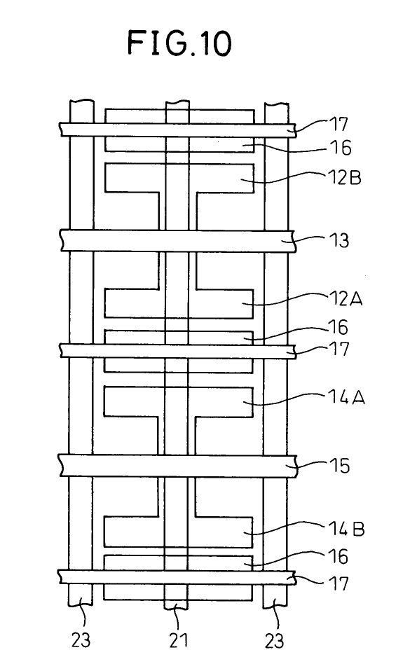

FIG. 10 is a diagram showing electrode shapes in the third embodiment. As shown schematically, the X bus electrode 13 and the Y bus electrode 15 are arranged at an equal interval in parallel to each other and the Z electrodes 16 and 17 are arranged at the center thereof in parallel to each other. Then, the ribs 23 extending in the direction perpendicular to the bus electrodes 13, 15, and 17 are arranged. Between the ribs 23, the address electrode is arranged. At each portion defined by the ribs 23, an X discharge electrode 12A extending downward from the X bus electrode 13, an X discharge electrode 12B extending upward from the X bus electrode 13, a Y discharge electrode 14A extending upward from the Y bus electrode 15, a Y discharge electrode 14B extending downward from the Y bus electrode 15, and the Z discharge electrode 16 extending both upward and downward from the Z bus electrode 17 are provided. The edges of the X discharge electrodes 12A and 12B, the edges of the Y discharge electrodes 14A and 14B, and the edges of the Z discharge electrode 16 in opposition to each other are parallel to the direction in which the X bus electrode 13, the Y bus electrode 15, and the Z electrode 17 extend.

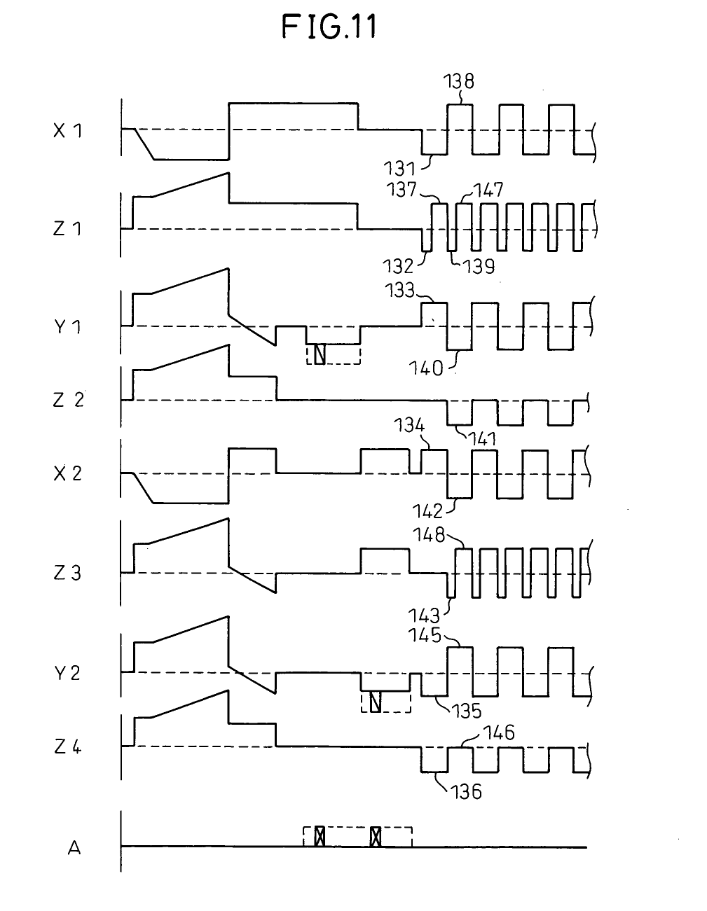

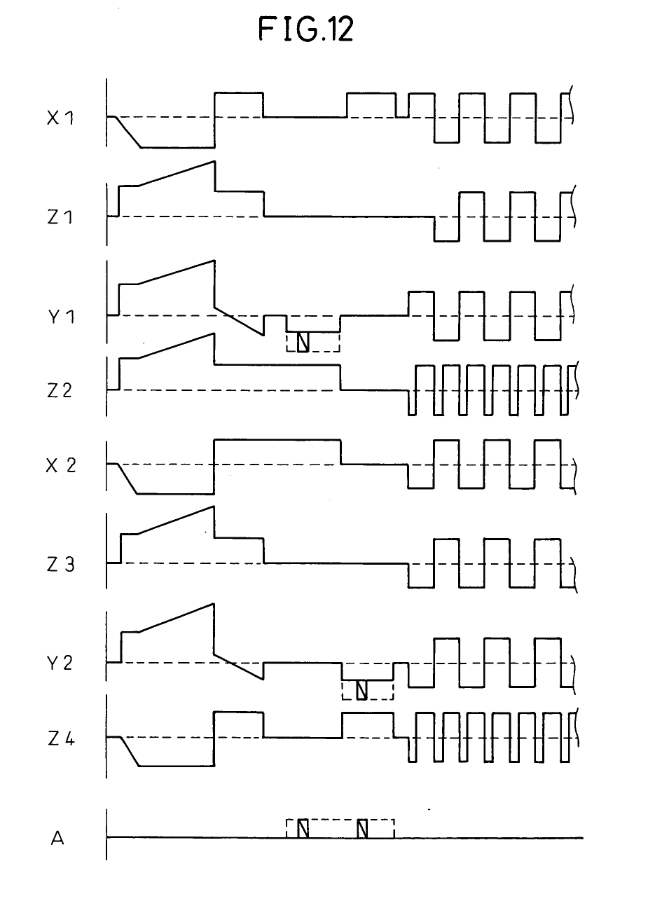

FIG. 11 and FIG. 12 are diagrams showing drive waveforms of the PDP device in the third embodiment: FIG. 11 shows drive waveforms in the odd-numbered field and FIG. 12 shows drive waveforms in the even-numbered field. The drive waveforms to be applied to the X electrode, the Y electrode, and the address electrode are the same as the drive waveforms described in Japanese Patent No. 2801893 etc., and to the Z electrode provided between the X electrode and the Y electrode between which a discharge is caused to occur, the same drive waveforms as those shown in FIG. 7 and FIG. 8 are applied, and drive waveforms that prevent the occurrence of a discharge and propagation of a discharge are applied to the Z electrode provided between the X electrode and the Y electrode between which no discharge is caused to occur. First, the drive waveforms in the odd-numbered field are explained below.

The drive waveforms during the reset period are the same as the drive waveforms in the second embodiment and to the Z electrodes in the four groups, the drive waveforms applied to the Z electrode shown in FIG. 7 are applied. Due to this, a reset discharge is caused to occur and all the cells are put into a uniform state.

During the first half of the address period, a predetermined potential (for example, +Vs) is applied to an odd-numbered X electrode X1 and a Z electrode Z1 in the first group, an even-numbered X electrode X2, an even-numbered Y electrode Y2, and Z electrodes Z2 to Z4 in the second to fourth groups are set to 0 V, and in a state in which a predetermined negative potential is applied to an odd-numbered Y electrode Y1, the scan pulse 107 is further applied sequentially. In accordance with the application of the scan pulse 107, the address pulse 108 is applied to the address electrode in a cell to be lit. Due to this, a discharge is caused to occur between the odd-numbered Y electrode Y1 to which the scan pulse has been applied and the address electrode to which the address pulse has been applied, and with this as a trigger, a discharge is caused to occur between the odd-numbered X electrode X1 and the odd-numbered Y electrode Y1 and between the Z electrode Z1 in the first group and the odd-numbered Y electrode Y1. Due to this address discharge, negative wall charges are formed in the vicinity of the odd-numbered X electrode X1 and the Z electrode Z1 in the first group (at the surface of the dielectric layer) and positive wall charges are formed in the vicinity of the odd-numbered Y electrode Y1. As no address discharge is caused to occur in a cell to which neither a scan pulse nor an address pulse is applied, the wall charges at the time of reset are maintained. During the first half of the address period, the above-mentioned operation is carried out by sequentially applying the scan pulse to all of the odd-numbered Y electrodes Y1.

During the second half of the address period, a predetermined potential is applied to the even-numbered X electrode X2 and the Z electrode Z3 in the third group, the odd-numbered X electrode X1, the odd-numbered Y electrode Y1, and the Z electrodes Z1, Z2, and Z4 in the first, second, and fourth groups are set to 0 V, and in a state in which a predetermined negative potential is applied to the even-numbered Y electrode Y2, the scan pulse 107 is further applied sequentially. In accordance with the application of the scan pulse 107, the address pulse 108 is applied to the address electrode in a cell to be lit. Due to this, a discharge is caused to occur between the even-numbered Y electrode Y2 to which the scan pulse has been applied and the address electrode to which the address pulse has been applied, and with this as a trigger, a discharge is caused to occur between the even-numbered X electrode X2 and the even-numbered Y electrode Y2 and between the Z electrode Z3 in the third group and the even-numbered Y electrode Y2. Due to this address discharge, negative wall charges are formed in the vicinity of the even-numbered X electrode X2 and the Z electrode Z3 in the third group and positive wall charges are formed in the vicinity of the even-numbered Y electrode Y2. During the second half of the address period, the above-mentioned operation is carried out by sequentially applying the scan pulse to all of the even-numbered Y electrodes Y2.

In the above-mentioned manner, addressing of the display lines between the odd-numbered X electrode X1 and the odd-numbered Y electrode Y1 and between the even-numbered X electrode X2 and the even-numbered Y electrode Y2, that is, addressing of the odd-numbered display lines is completed. In a cell in which the address discharge has been caused to occur, positive wall charges are formed in the vicinity of the odd-numbered Y electrode Y1 and the even-numbered Y electrode Y2 and negative wall charges are formed in the vicinity of the odd-numbered X electrode X1, the even-numbered X electrode X2, and the Z electrodes Z1 and Z3 in the first and third groups.

During the sustain discharge period, first, negative sustain discharge pulses 131 and 135 having the potential −Vs are applied to the odd-numbered X electrode X1 and the even-numbered Y electrode Y2, positive sustain discharge pulses 133 and 134 having the potential +Vs are applied to the odd-numbered Y electrode Y1 and the even-numbered X electrode X2, a negative pulse 132 having the potential −Vs is applied to the Z electrode Z1 in the first group, a negative pulse 136 having the potential −Vs is applied to the Z electrode Z4 in the fourth group, and 0 V is applied to the Z electrode Z2 in the second group and the Z electrode Z3 in the third group. At the odd-numbered X electrode X1 and the Z electrode Z1 in the first group, the voltage due to the negative wall charges is added to the potential −Vs, and at the odd-numbered Y electrode Y1, the voltage due to the positive wall discharges is added to the potential +Vs, and a large voltage is applied between them. Due to this, a discharge is first caused to start across the small distance between the Z electrode Z1 in the first group and the odd-numbered Y electrode Y1 and, with this as a trigger, a transition takes place to a discharge across the large distance between the odd-numbered X electrode X1 and the odd-numbered Y electrode Y1. When this discharge comes to an end, a positive pulse 137 having the potential +Vs is applied to the Z electrode Z1 in the first group as in the second embodiment. Due to this, positive wall charges are formed in the vicinity of the odd-numbered X electrode X1 and negative wall charges are formed in the vicinity of the odd-numbered Y electrode Y1 and the Z electrode Z1 in the first group.

At this time, at the even-numbered X electrode X2 and the Z electrode Z3 in the third group, the voltage due to the negative wall charges is added to the potential +Vs and at the even-numbered Y electrode Y2, the voltage due to the positive wall charges is added to the potential −Vs, therefore, the voltage between electrodes is reduced and no discharge is caused to occur and, therefore, the wall charges are maintained.

Further +Vs is applied to the odd-numbered Y electrode Y1 and the even-numbered X electrode X2 and −Vs is applied to the even-numbered Y electrode Y2 and the odd-numbered X electrode X1, therefore, no discharge is caused to occur. The potential Vs is applied to the odd-numbered Y electrode Y1, 0 V is applied to the Z electrode Z2 in the second group, the voltage due to the positive wall charges is added at the odd-numbered Y electrode Y1 and, thus, the voltage between the odd-numbered Y electrode Y1 and the Z electrode Z2 in the second group becomes high, however, the voltage applied to the Z electrode Z2 in the second group is 0 V, and no wall charges are formed at the Z electrode Z2 in the second group, therefore, the voltage due to the wall charges is not added and, therefore, no discharge occurs. Conversely speaking, it is necessary to set the voltage to be applied to the Z electrode Z2 in the second group to a voltage that does not cause a discharge to occur. However, it is preferable for the voltage to be applied to the Z electrode Z2 in the second group to be lower than the voltage +Vs to be applied to the neighboring odd-numbered Y electrode Y1 and the even-numbered X electrode X2. This is because, if a sustain discharge is caused to occur between the odd-numbered X electrode X1 and the odd-numbered Y electrode Y1, electrons having a tendency to move start to move from the odd-numbered X electrode X1 toward the odd-numbered Y electrode Y1 and if the voltage of the Z electrode Z2 in the second group is the same as the voltage of the odd-numbered Y electrode Y1, the electrons continue to move toward the Z electrode Z2 in the second group as it is, and move as far as the even-numbered X electrode X2. If this happens, the next application of the sustain discharge pulse having the opposite polarity causes an erroneous discharge to occur, resulting in a display error. In contrast to this, as in the present embodiment, if the voltage of the Z electrode Z2 in the second group is reduced lower than the voltage of the odd-numbered Y electrode Y1, the movement of electrons can be prevented and an erroneous discharge can be prevented from occurring between neighboring display lines.

Next, positive sustain discharge pulses 138 and 145 having the potential +Vs are applied to the odd-numbered X electrode X1 and the even-numbered Y electrode Y2, negative sustain discharge pulses 140 and 142 having the potential −Vs are applied to the odd-numbered Y electrode Y1 and the even-numbered X electrode X2, negative pulses 139 and 143 having the potential −Vs are applied to the Z electrode Z1 in the first group and the Z electrode Z3 in the third group, a negative pulse 141 having −Vs is applied to the Z electrode Z2 in the second group, and a pulse 146 having 0 V is applied to the Z electrode Z4 in the fourth group. At the odd-numbered X electrode X1 and the Z electrode Z1 in the first group, positive wall charges are formed by the previous sustain discharge as described above and the voltage due to these charges is added to the potential +Vs and, at the odd-numbered Y electrode Y1, the voltage due to the negative wall charges formed by the previous sustain discharge is added to the potential −Vs, and a large voltage is applied between them. Further, at the even-numbered X electrode X2 and the Z electrode Z3 in the third group, the negative wall charges at the end of addressing are maintained and the voltage due to these charges is added to the potential −Vs and at the even-numbered Y electrode Y2, the positive wall charges at the end of addressing are maintained and the voltage due to these charges is added to the potential +Vs, and a large voltage is applied between them. Due to this, a discharge is caused to start across the small distance between the Z electrode Z1 in the first group and the odd-numbered Y electrode Y1 and across the small distance between the Z electrode Z3 in the third group and the even-numbered Y electrode Y2, and with this as a trigger, a transition takes place to a discharge across the large distance between the odd-numbered X electrode X1 and the odd-numbered Y electrode Y1 and across the large distance between the even-numbered X electrode X2 and the even-numbered Y electrode Y2. When this discharge comes to an end, as in the first embodiment, positive pulses 147 and 148 having the potential +Vs are applied to the first Z electrode Z1 in the first group and the Z electrode Z3 in the third group. Due to this, positive wall charges are formed in the vicinity of the odd-numbered X electrode X1 and the Z electrode Z1 in the first group and in the vicinity of the even-numbered X electrode X2 and the Z electrode Z3 in the third group, and negative wall charges are formed in the vicinity of the odd-numbered Y electrode Y1 and the even-numbered Y electrodes Y1 and Y2.

At this time, the same voltage −Vs is applied between the odd-numbered Y electrode Y1 and the even-numbered X electrode X2 and between the odd-numbered Y electrode Y1 and the Z electrode Z1 in the second group, and the same voltage +Vs is applied between the even-numbered Y electrode Y2 and the odd-numbered X electrode X1, therefore, no discharge is caused to occur. Further, the voltage Vs is applied between the even-numbered Y electrode Y2 and the Z electrode Z4 in the fourth group, however, no discharge is caused to occur, as described above, and the electrons generated in the neighboring cells are prevented from moving and an erroneous discharge is prevented from occurring.

After this, by applying the sustain discharge pulse while inverting the polarities and by applying the pulse to each Z electrode, the sustain discharge is caused to occur repeatedly.

As described above, the first sustain discharge is caused to occur only between the odd-numbered X electrode X1 and the odd-numbered Y electrode Y1 and no sustain discharge is caused to occur between the even-numbered X electrode X2 and the even-numbered Y electrode Y2, therefore, the numbers of sustain discharges are made equal to each other by controlling such that the sustain discharge is caused to occur only between the even-numbered X electrode X2 and the even-numbered Y electrode Y2 and that no sustain discharge is caused to occur between the odd-numbered X electrode X1 and the odd-numbered Y electrode Y1 at the end of the sustain discharge period.

The drive waveforms in the odd-numbered field are explained as above. As for the drive waveforms in the even-numbered field, the same drive waveform as that in the odd-numbered field is applied to the odd-numbered Y electrode Y1 and the even-numbered Y electrode Y2, the drive waveform applied to the even-numbered X electrode X2 in the odd-numbered field is applied to the odd-numbered X electrode X1, the drive waveform applied to the odd-numbered X electrode X1 in the odd-numbered field is applied to the even-numbered X electrode X2, the drive waveform applied to the Z electrode Z2 in the second group in the odd-numbered field is applied to the Z electrode Z1 in the first group, the drive waveform applied to the Z electrode Z1 in the first group in the odd-numbered field is applied to the Z electrode Z2 in the second group, the drive waveform applied to the Z electrode Z4 in the fourth group in the odd-numbered field is applied to the Z electrode Z3 in the third group, and the drive waveform applied to the Z electrode Z3 in the third group in the odd-numbered field is applied to the Z electrode Z4 in the fourth group.

The PDP device in the third embodiment is described as above, however, the modification examples explained in the first and second embodiments can also be applied to the ALIS system PDP device in the third embodiment.

As described above, according to the present invention, it is possible to provide a plasma display panel capable of improving the emission efficiency of the PDP and of realizing a PDP device with a high-quality display at low cost.

We claim:

1. A method for driving a plasma display panel comprising:
a plurality of first and second electrodes alternately provided in parallel to each other and between adjacent electrodes of which, a repetitive discharge is caused to occur; and
a plurality of third electrodes each provided between the first and second electrodes, between which the repetitive discharge is caused to occur, and covered with a dielectric layer,
wherein regardless of display data, when a reset discharge, which is caused to occur in every cell, is caused to occur between the first and second electrodes, the third electrode is set to a potential that makes the third electrode function as an anode for the electrode used as a cathode during the reset discharge between the first and second electrodes.

2. The method for driving a plasma display panel as set forth in claim 1 wherein, when the reset discharge is caused to occur, the third electrode is set to substantially the same potential as that of the electrode used as an anode during the reset discharge between the first and second electrodes.

3. The method for driving a plasma display panel as set forth in claim 1, wherein the plurality of first and second electrodes make pairs, the third electrode is provided between each pair of the first electrode and the second electrode, and a common potential is applied to the plurality of third electrodes.

4. The method for driving a plasma display panel as set forth in claim 1, wherein:
the plurality of third electrodes are each provided at every portion between the plurality of first electrodes and the plurality of second electrodes;
an odd-numbered field in which a discharge for display is caused to occur between the second electrode and the first electrode adjacent to one side thereof, and an even-numbered field in which a discharge for display is caused to occur between the second electrode and the first electrode adjacent to the other side thereof are provided; and
when the reset discharge is caused to occur, a common potential is applied to the plurality of third electrodes.

5. The method for driving a plasma display panel as set forth in claim 1 wherein, during the period in which a repetitive discharge is caused to occur between the first and second electrodes, the third electrode provided between the first electrode and the second electrode between which the discharge is caused to occur is set to substantially the same potential as that of the electrode that is the first electrode or the second electrode used as an anode or a cathode at least during the discharge period, and after the discharge almost comes to an end, it is set to substantially the same potential as that of the electrode having the other polarity.

6. A plasma display device comprising:
a plurality of first and second electrodes alternately provided in parallel to each other and between adjacent electrodes of which, a repetitive discharge is caused to occur; and
a plurality of third electrodes each provided between the first and second electrodes between which the repetitive discharge is caused to occur and covered with a dielectric layer, further comprising:
a first electrode drive circuit for driving the plurality of first electrodes;
a second electrode drive circuit for driving the plurality of second electrodes; and
a third electrode drive circuit for driving the plurality of third electrodes wherein, regardless of display data, when a reset discharge, which is caused to occur in every cell, is caused to occur between the first and second electrodes, the third electrode drive circuit sets the third electrode to a potential that makes the third electrode function as an anode for the electrode used as a cathode during the reset discharge between the first and second electrodes.

7. The plasma display device as set forth in claim 6, wherein when the reset discharge is caused to occur, the third electrode drive circuit sets the third electrode to substantially the same potential of the electrode used as an anode during the reset discharge between the first and second electrodes.

8. The plasma display device as set forth in claim 6, wherein:
the plurality of first and second electrodes make pairs and the third electrode is provided between each pair of the first electrode and the second electrode; and
the third electrode drive circuit applies a common potential to the plurality of third electrodes.

9. The plasma display device as set forth in claim 6, wherein:
the plurality of third electrodes are each provided at every portion between the plurality of first electrodes and the plurality of second electrodes;
an odd-numbered field in which a discharge for display is caused to occur between the second electrode and the first electrode adjacent to one side thereof, and an even-numbered field in which a discharge for display is caused to occur between the second electrode and the first electrode adjacent to the other side thereof are provided; and
when the reset discharge is caused to occur, the third electrode drive circuit applies a common potential to the plurality of third electrodes.

10. The plasma display device as set forth in claim 6 wherein, during the period in which a repetitive discharge is caused to occur between the first and second electrodes, the third electrode drive circuit sets the third electrode, provided between the first electrode and the second electrode between which the discharge is caused to occur, to substantially the same potential as that of the electrode that is the first electrode or the second electrode used as an anode or a cathode at least during the discharge period, and after the discharge almost comes to an end, the third electrode drive circuit sets the third electrode to substantially the same potential as that of the electrode having the other polarity.
